(19) United States
(12) Patent Application Publication
(10) Pub. No.: US 2004/0047701 A1
(43) Pub. Date: Mar. 11, 2004

(54) CNC machine tool for rotating a workpiece by a preset angle per one-revolution rotation of a rotating shaft on a worktable

(76) Inventor: Hsi-Kuan Chen, Taichung City (TW)

Correspondence Address: LADAS & PARRY, 224 SOUTH MICHIGAN AVENUE, SUITE 1200, CHICAGO, IL, 60604, US

(21) Appl. No.: 10/335,840

(22) Filed: Jan. 2, 2003

(30) Foreign Application Priority Data
Sep. 9, 2002 (TW) 091214140

(51) Int. Cl. B23Q 3/06

(52) U.S. Cl. 409/221

(57) ABSTRACT

A CNC machine tool includes a worktable disposed movably on a machine bed and having a fixed first engaging element, a working disk mounted rotatably on the worktable for holding a workpiece to be cut, and a rotating unit with a rotating shaft journalled on the worktable. A second engaging element is fixed to the working disk. The working disk is rotated mechanically by a preset angle by the rotating unit per one-revolution rotation of the rotating shaft on the worktable. When the rotating unit does not rotate the working disk during rotation of the rotating unit, it activates the first and second engaging elements to engage each other so as to fix the working disk relative to the worktable.

### CROSS REFERENCE TO RELATED APPLICATION

This application claims priority of Taiwanese Application No. 91214140, filed on Sep. 9, 2002.

### BACKGROUND OF THE INVENTION

1. Field of the Invention

This invention relates to a CNC (Computer Numerical Control) machine tool, and more particularly to a CNC machine tool, which can rotate a workpiece by a preset angle per one-revolution rotation of a rotating shaft on a worktable.

2. Description of the Related Art

Referring to FIG. 1, a CNC machine tool 10 is shown to include a workpiece-rotating device 11, which is disposed on a worktable 12 that is mounted movably on a machine bed and that can move in horizontal directions (X, Y) under CNC control. A vertical working disk ill is connected rotatably to the worktable 12 by means of the workpiece-rotating device 11 for holding a workpiece (not shown) to be cut thereon. The workpiece-rotating device 11 is provided with a stepping motor 13 for rotating the working disk 111. A carrier 14 is disposed on the machine bed, and can move in a vertical direction (Z). A cutter 15 is mounted fixedly on the carrier 14. As such, the workpiece (not shown) can be rotated on the worktable 12 by a preset angle by the workpiece-rotating device 11 upon each output of the motor 13.

The aforesaid conventional CNC machine tool 10 suffers from the following disadvantages:

(1) To drive the motor 13, a power cable (not shown) and a signal cable (not shown) are connected thereto. It is expensive to arrange the power cable and the signal cable on the machine 10. Furthermore, some elements, which are disposed among the motor 13, the power cable, and the signal cable, are required to often replace, thereby resulting in difficulties in maintenance and repair.

(2) Because no means is provided for preventing rotation of the working disk 111 relative to the worktable 12, the working disk 111 is kept in a rotatable condition with respect to the worktable 12, thereby resulting in poor cutting quality, especially for comparatively heavy workpieces.

### SUMMARY OF THE INVENTION

The object of this invention is to provide a CNC machine tool, which includes a working disk that is rotated mechanically by a rotating unit so that a stepping motor for driving the working disk can be omitted, and means for preventing rotation of the working disk relative to a worktable only when the working disk does not rotate.

According to this invention, a CNC machine tool includes a worktable disposed movably on a machine bed and having a fixed first engaging element, a working disk mounted rotatably on the worktable for holding a workpiece to be cut, and a rotating unit with a rotating shaft journalled on the worktable. A second engaging element is fixed to the working disk. The working disk is rotated mechanically by a preset angle by the rotating unit per one-revolution rotation of the rotating shaft on the worktable. When the rotating unit does not rotate the working disk during rotation of the rotating unit, it activates the first and second engaging elements to engage each other so as to fix the working disk relative to the worktable.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a perspective view of a conventional CNC machine tool;

FIG. 2 is a perspective view of the preferred embodiment of a CNC machine tool according to this invention;

FIG. 3 is a perspective view showing a rotating unit, a driven unit, a clutch unit, and a positioning unit of the preferred embodiment, in which a casing is shown in phantom lines;

FIG. 4 is another perspective view showing the rotating unit, the driven unit, the clutch unit, and the positioning unit of the preferred embodiment, but viewed from another angle;

FIG. 5 is a schematic fragmentary sectional view of the preferred embodiment taken along a vertical direction, illustrating connection between a guiding wheel and a plurality of driven elements;

FIG. 6 is a schematic fragmentary sectional view of the preferred embodiment taken along a horizontal line when a central shaft is disposed at a connecting position, where first and second engaging elements engage each other;

FIG. 7 is a view similar to FIG. 6 when the central shaft is disposed at a disconnecting position, where the first and second engaging elements are removed from each other;

FIG. 8 illustrates movement of a roller on one of the driven elements along a guiding slot in the guiding wheel; and

FIG. 9 illustrates movement of a roller on a driven swing arm of the rotating unit along a periphery of a driving cam wheel.

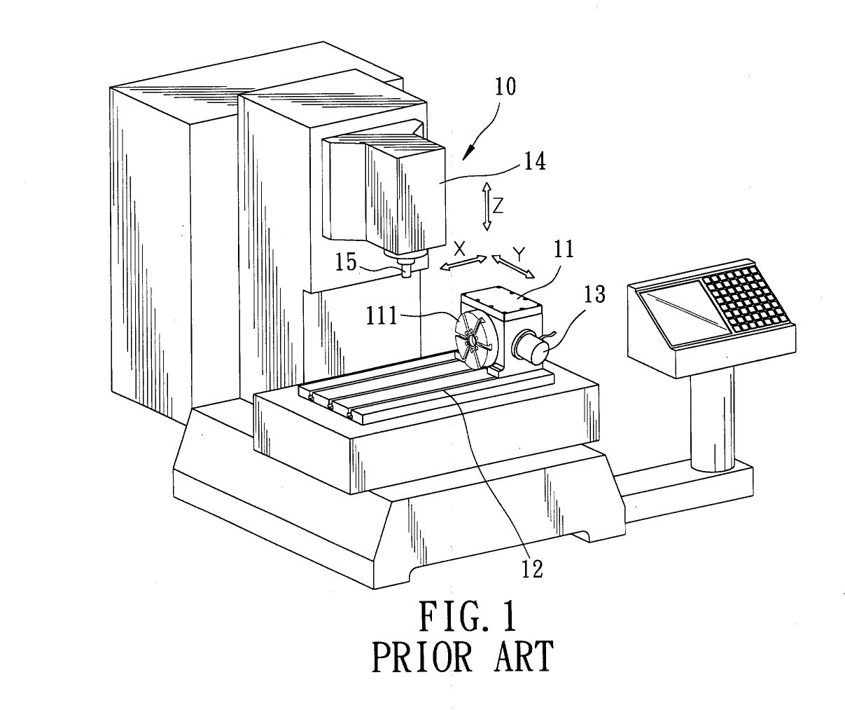

### DETAILED DESCRIPTION OF THE PREFERRED EMBODIMENT

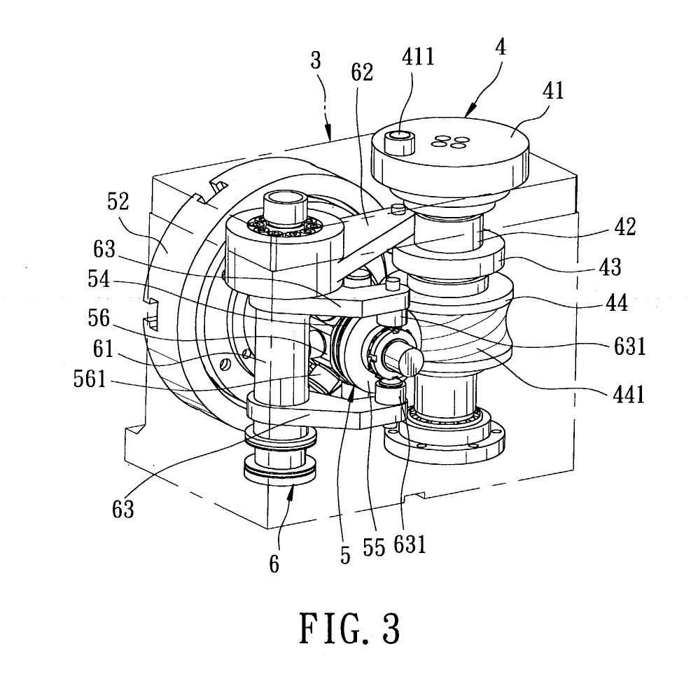

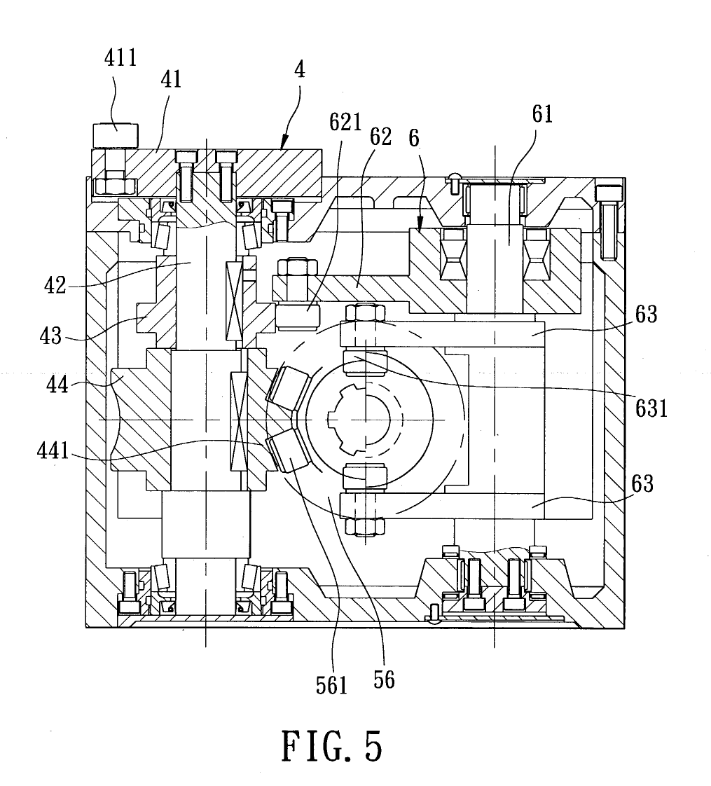

Referring to FIGS. 3, 4, and 5, the preferred embodiment of a CNC machine tool according to this invention is shown to include a machine bed 21, a worktable 22, a carrier 23, a numerical control unit 24, a casing 3, a rotating unit 4, a driven unit 5, a clutch unit 6, and a positioning unit 7.

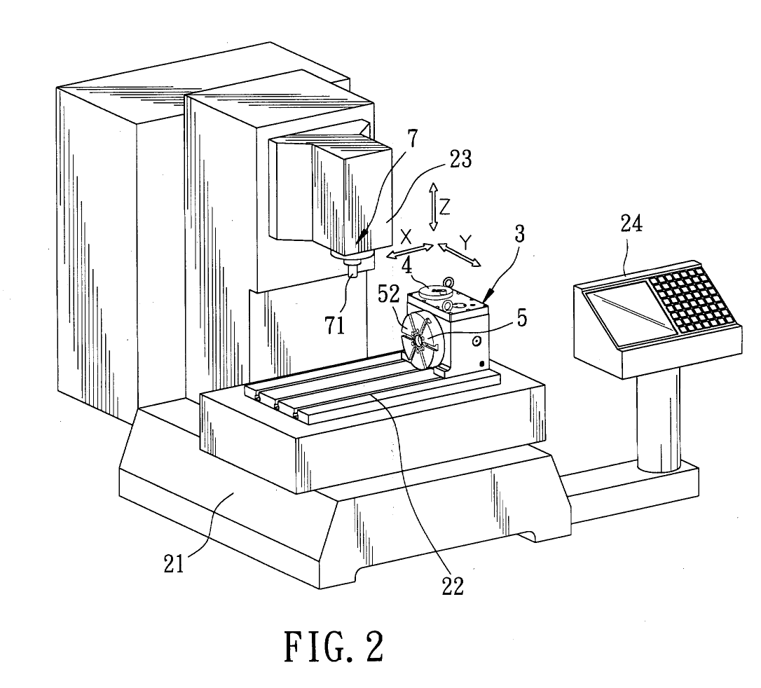

The worktable 22 is disposed movably on the machine bed 21, and is movable on the machine bed 21 under CNC control in horizontal directions (X, Y) (see FIG. 2). The carrier 23 is disposed vertically and movably relative to and above the machine bed 21, and is movable relative to the machine bed 21 in a vertical direction (Z) (see FIG. 2) under the CNC control of the numerical control unit 24 in a known manner.

The casing 3 is fixed on the worktable 22, and has an outer surface that is provided with a toothed first engaging element 31 fixed thereon.

The rotating unit 4 includes a horizontal rotating disk 41, a vertical rotating shaft 42, a driving cam wheel 43, and a guiding wheel 44. The rotating shaft 42 is journalled on and is disposed axially and movably within the casing 3. The rotating disk 41 is connected fixedly to a top end of the rotating shaft 42, and has a top surface that is provided with a fixed rotating center element 411, which is eccentric from the axis of the rotating shaft 42. In this embodiment, the positioning element 441 is configured as a cylindrical sleeve.

The driving cam wheel 43 is sleeved fixedly on the rotating shaft 42. Referring to FIG. 9, the driving cam wheel 43 includes a small-radius cam surface (431a), a driving cam surface (431b), a large-radius cam surface (431c), and a transitional cam surface (431d). The small-radius cam surface (431a) has a uniform radius, a leading end, and a tail end. The leading and tail ends of the small-radius cam surface (431a) are spaced apart from each other by an angle of 25°. The large-radius cam surface (431c) has a uniform-radius that is larger than that of the small-radius cam surface (431a), a leading end, and a tail end. The leading and tail ends of the large-radius cam surface (431c) are spaced apart from each other by an angle of 190°. The driving cam surface (431b) has a leading end coupled with the tail end of the small-radius cam surface (431a) at a point (A2), a tail end coupled with the leading end of the large-radius cam surface (431C) at a point (A3), and a diameter increasing gradually from the leading end of the driving cam surface (431b) to the tail end of the driving cam surface (431b) The leading and tail ends of the driving cam surface (431b) are spaced apart from each other by an angle of 60°. The transitional cam surface (431d) has a leading end coupled with the tail end of the large-radius cam surface (431c) at a point (A4), and a tail end coupled with the leading end of the small-radius cam surface (431a) at a point (A1). The leading and tail ends of the transitional cam surface (431d) are spaced apart from each other by an angle of 85°.

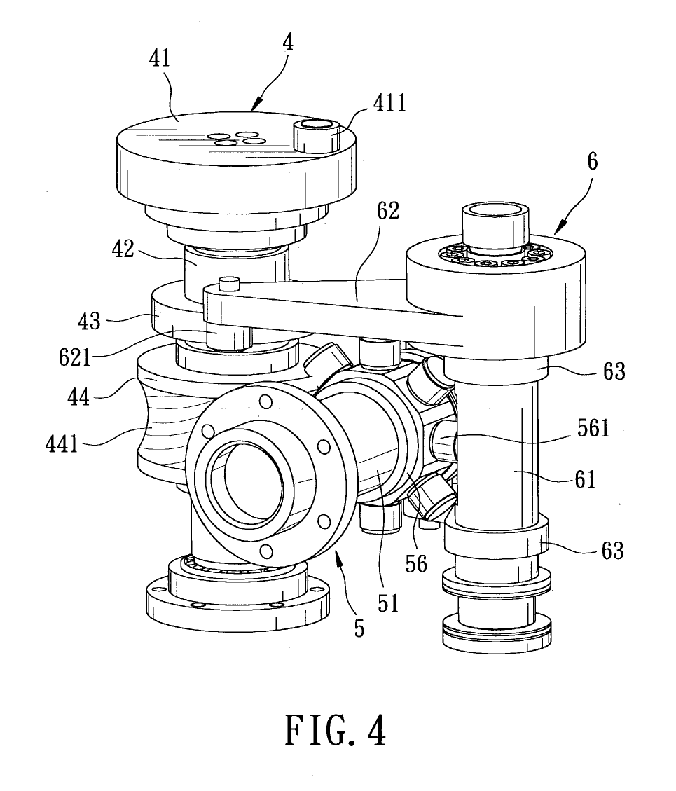

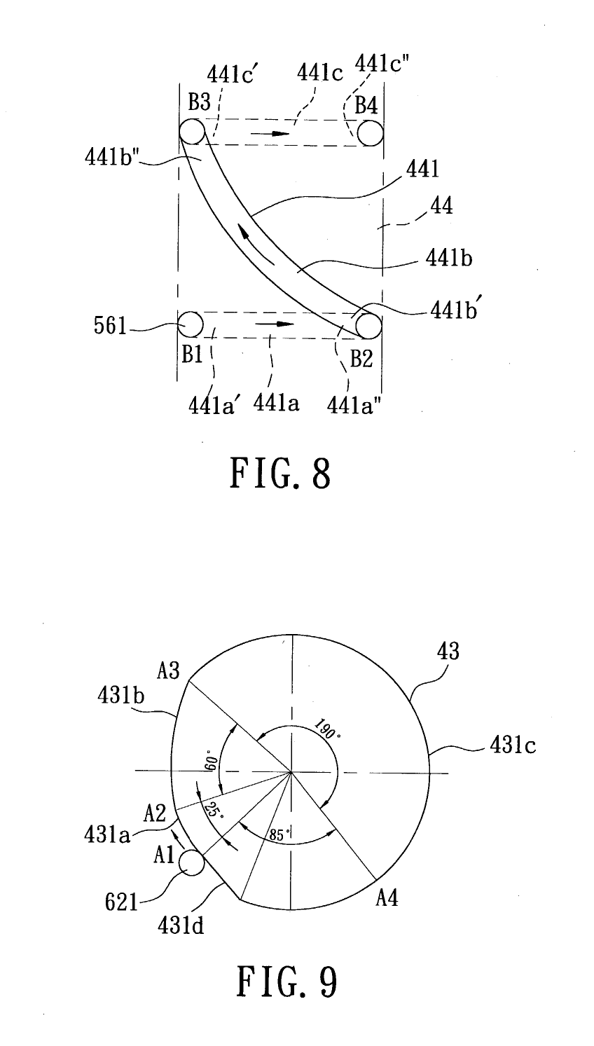

Referring to FIGS. 3, 4 and 8, the guiding wheel 44 is sleeved fixedly on the rotating shaft 42, and has an annular outer surface that is formed with a guiding slot 441. Referring to FIG. 8, the guiding slot 441 has an entrance slot portion (441a) (not visible in FIGS. 3 and 4), a helical slot portion (441b), and an exit slot portion (441c) (not visible in FIGS. 3 and 4). The entrance slot portion (441a) is formed at a lower end of the guiding wheel 44, extends from a point (B1) to a point (B2) along a circumferential direction of the guiding wheel 44, and has a leading end (441a′) and a tail end (441a″). The helical slot portion (441b) extends from the point (B2) to a point (B3) along a helical path, and has a lower leading end (441b′) coupled with the tail end (441a″) of the entrance slot portion (441a), and an upper tail end (441b″). The exit slot portion (441c) extends from the point (B3) to a point (B4) along the circumferential direction of the guiding wheel 44, and has a leading end (441c′) coupled with the tail end (441b″) of the helical slot portion (441b) and a tail end (441c″). The guiding slot 441 extends about the axis of the guiding wheel 44 by an angle of 360°. That is to say, the points (B1, B4) are aligned along a vertical direction.

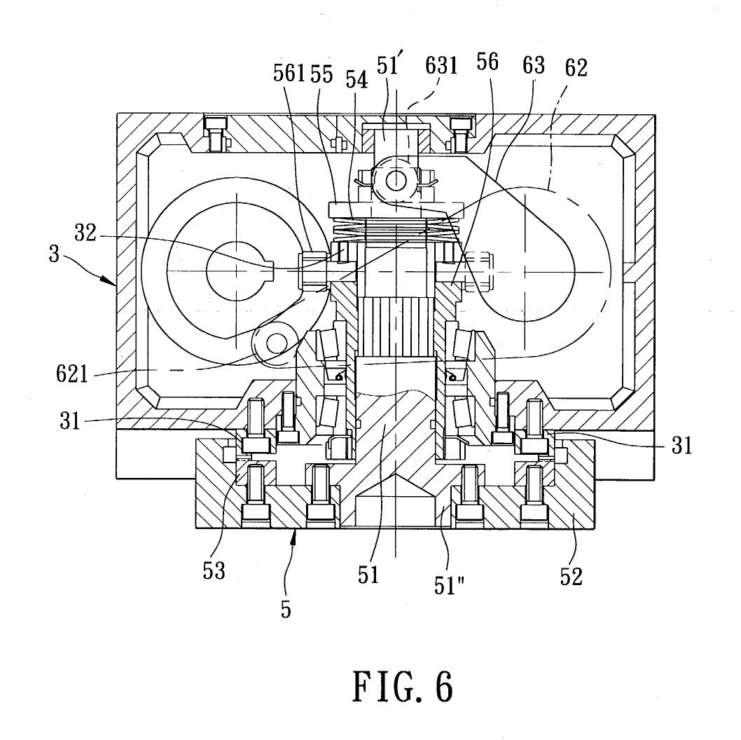

Referring again to FIGS. 3, 4, 5, and 6, the driven unit 5 includes a horizontal central shaft 51, a vertical working disk 52, a toothed second engaging element 53, a spring member 54 in the form of a coiled compression spring, a ring 55, and a plurality of angularly equidistant driven elements 56. The central shaft 51 is journalled on and is disposed movably within the casing 3, and has an inner end 51′ (see FIG. 6) that is disposed in the casing 3, and an outer end 51″ that is disposed outside of the casing 3. The working disk 52 is adapted to mount a workpiece (not shown) to be cut thereon, is connected fixedly to the outer end 51″ of the central shaft 51, and is disposed outside of the casing 3. The second engaging element 53 is disposed fixedly on the working disk 52. The ring 55 is sleeved fixedly on the inner end 51′ of the central shaft 51. The driven elements 56 are connected fixedly to and extend radially and outwardly from the central shaft 51, and are arranged along a circumferential direction of the central shaft 51. Each of the driven elements 56 has an outer end, which is provided with a rotatable roller 561 that is movable along the guiding slot 441 in the guiding wheel 44. The number of the driven elements 56 is N.

The spring member 54 biases the central shaft 51 inwardly relative to the casing 3 so as to move the working disk 52 toward the casing 3, thereby permitting engagement of the second engaging element 53 with the first engaging element 31. In this embodiment, the spring member 54 is sleeved on the central shaft 51, and is disposed between the ring 55 and a stop member 32 (see FIG. 6). The stop member 32 is fixed in the casing 3, and is disposed between the ring 55 and the driven elements 56.

The clutch unit 6 includes a vertical clutch shaft 61 (see FIG. 3) journalled within the casing 3, a driven swing arm 62 cooperating with the driving cam wheel 43, and a driving swing arm 63 cooperating with the ring 55. The driven and driving swing arms 62, 63 extend integrally, radially, and outwardly from the clutch shaft 61 so as to rotate synchronously with each other. The driven swing arm 62 has a free end, which is provided with a rotatable roller 621 that is movable along the small-radius cam surface (431a) (see FIG. 9), the driving cam surface (431b) (see FIG. 9), the large-radius cam surface (431c) (see FIG. 9), and the transitional cam surface (431d) (see FIG. 9) of the driving cam wheel 43.

The spring member 54 biases the ring 55 to press against the driving swing arm 63. Because the driven and driving swing arms 62, 62 are connected fixedly to the clutch shaft 61, the roller 621 of the driven swing arm 62 is brought into engagement with the driving cam wheel 43 of the rotating unit 4.

The positioning unit 7 includes a positioning element 71, which is disposed fixedly on the carrier 23, and is configured as a projecting post that extends downwardly from the carrier 23. In this embodiment, the positioning element 71 is a cutter.

In operation, the rotating shaft 42 is rotated with respect to the worktable 22 by controlling the numerical control unit 24 in a known manner that will be described in the succeeding paragraph.

The numerical control unit 24 is operated to move the worktable 22 horizontally so as to align the positioning element 71 with the rotating center element 411. The carrier 23 is moved downwardly under the control of the numerical control unit 24 so as to permit the positioning element 71 to engage fittingly the rotating center element 411 such that the rotating center element 411 is sleeved rotatably on the positioning element 71, thereby preventing displacement of the rotating center element 411 relative to the positioning element 71 while permitting rotation of the rotating center element 411 relative to the positioning element 411. At this time, the worktable 22 can be moved horizontally on the machine bed 21 under the control of the numerical control unit 24 so as to rotate the rotating disk 41 about the rotating center element 411, thereby permitting rotation of the rotating shaft 42 within the casing 3.

Referring to FIGS. 3 through 9, during rotation of the rotating shaft 42 relative to the worktable 22, the roller 621 of the driven swing arm 62 of the clutch unit 6 is biased to press against the periphery of the driving cam wheel 43 due to the presence of the spring member 54.

When the roller 621 of the driven swing arm 62 of the clutch unit 6 moves from the point (A1) to the point (A2) along the small-radius cam surface (431a), the second engaging element 53 engages the first engaging element 31 so as to prevent rotation of the working disk 52 relative to the worktable 22.

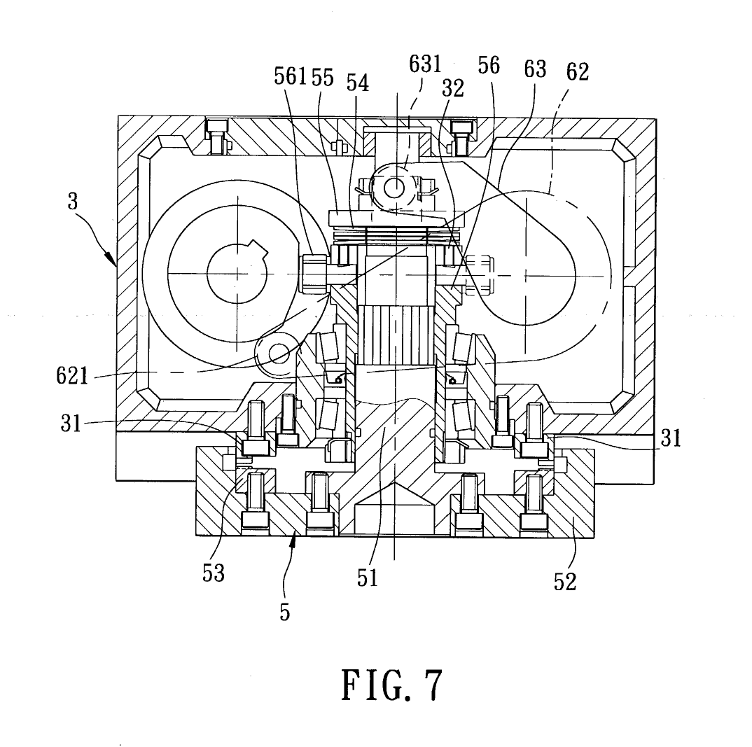

When the roller 621 moves from the point (A2) to the point (A3) along the driving cam surface (431b), the driving swing arm 63 of the clutch unit 6 contacts and pushes the ring 55 toward the stop member 32 so as to compress the spring member 54 such that the central shaft 51 in the casing 3 moves from a connecting position shown in FIG. 6, where the first and second engaging elements 31, 53 engage each other, to a disconnecting position, shown in FIG. 7, where the first and second engaging elements 31, 53 are removed from each other.

When the roller 621 of the driven swing arm 62 of the clutch unit 6 moves from the point (A1) to the point (A3), the roller 561 of one of the driven elements 56 of the driven unit 5 enters the leading end (441a′) of the entrance slot portion (441a) of the guiding slot 441, and moves from the point (B1) to the point (B2) along the entrance slot portion (441a). As such, the driven elements 56 are fixed relative to the worktable 22 so that the working disk 52 cannot rotate on the worktable 22.

When the roller 621 of the driven swing arm 62 of the clutch unit 6 moves from the point (A3) to the point (A4) along the large-radius cam surface (431c), the driven and driving swing arms 62, 63 are fixed relative to the worktable 22 so that the central shaft 51 of the driven unit 5 is kept in the disconnecting position shown in FIG. 7, thereby permitting rotation of the working disk 52 on the worktable 22. At the same time, the roller 561 of the one of the driven elements 56 moves from the point (B2) to the point (B3) along the helical slot portion (441b) so that the driven elements 56 are rotated by a preset angle of 360/N degrees (N is the number of the driven elements 56).

When the roller 621 of the driven swing arm 62 of the clutch unit 6 moves from the point (A4) to the point (A1) along the transitional slot portion (431d), the driving swing arm 63 is rotated back to its original position, where the central shaft 51 is disposed at the connecting position shown in FIG. 6. At the same time, the roller 561 of the one of the driven elements 56 moves from the point (B3) to the point (B4) along the exit slot portion (441c), and exits from the tail end (441c″) of the exit slot portion (441c) so that the driven elements 56 and the working disk 52 cannot rotate on the worktable 22. When the roller 621 of the driven swing arm 62 of the clutch unit 6 moves to the point (A1), the roller 561 of the one of the driven elements 56 exits from the tail end (441c″) of the exit slot portion (441c), and the roller 561 of a succeeding one of the driven elements 56 enters the leading end (441a′) of the entrance slot portion (441a). As such, the driven elements 56 can engage the guiding slot 441 in the guiding wheel 44 of the rotating unit 4 in turn when the rotating unit 4 rotates.

From the forgoing description, it can be seen that the working disk 52 can rotate by an angle of 360/N degrees per one-revolution rotation of the rotating shaft 42 on the worktable 22, thereby permitting intermittent rotation of the central shaft 51 on the worktable 22.

This invention has the following advantages:

(1) Because the central shaft 51 is driven mechanically by the rotating shaft 42, there is no need to provide a stepping motor, a signal cable, and a power cable for driving the working disk 52.

(2) When the rotating shaft 42 does not rotate the central shaft 51 during rotation of the rotating shaft 42, the central shaft 51 is prevented from rotation relative to the worktable 22 due to engagement of the first and second engaging elements 31, 53, thereby resulting in good cutting quality. Furthermore, the CNC machine tool of this invention is suitable for cutting comparatively heavy workpieces.

With this invention thus explained, it is apparent that numerous modifications and variations can be made without departing the scope and spirit of this invention. It is therefore intended that this invention be limited only as indicated by the appended claims.

I claim:

1. A CNC machine tool comprising:
a machine bed;
a worktable disposed movably on said machine bed and movable on said machine bed under CNC control, said worktable being provided with a first engaging element fixed thereon;
a rotating unit including
a vertical rotating shaft journalled on and disposed axially and movably on said worktable, and
a guiding wheel sleeved fixedly on said rotating shaft and having an annular outer surface that is formed with a guiding slot, which has an entrance slot portion that extends along a circumferential direction of said guiding wheel and that has a leading end and a tail end, a helical slot portion that has a leading end coupled with said tail end of said entrance slot portion and a tail end, and an exit slot portion that extends along the circumferential direction of said guiding wheel and that has a leading end coupled with said tail end of said helical slot portion, and a tail end;
a driven unit including
a horizontal central shaft journalled on said worktable, said central shaft being movable on said worktable between a connecting position and a disconnecting position,
a second engaging element disposed fixedly on said central shaft,
a spring member for biasing said second engaging element to engage said first engaging element of said worktable so as to prevent rotation of said central shaft on said worktable, and
a plurality of angularly equidistant driven elements connected fixedly to and extending radially and outwardly from said central shaft and arranged along a circumferential direction of said central shaft, said driven elements being rotatable about said central shaft to engage said guiding slot in said guiding wheel of said rotating unit in turn when said rotating unit rotates so that an end of each of said driven elements can move along said entrance slot portion, said helical slot portion, and said exit slot portion and can subsequently exit from said tail end of said exit slot portion of said guiding slot, the number of said driven elements being N, said driven elements cooperating with said guiding slot in said guiding wheel such that said central shaft can rotate by an angle of 360/N degrees per one revolution of said rotating shaft, thereby permitting intermittent rotation of said central shaft on said worktable; and
a clutch unit connected between said rotating unit and said driven unit, said clutch unit being driven by said rotating unit to move said central shaft to said disconnecting position when said end of each of said driven elements moves along said helical slot portion so as to separate said second engaging element of said driven unit from said first engaging element of said worktable, thereby permitting rotation of said central shaft on said worktable, said clutch unit being driven by said rotating unit to move said central shaft to said connecting position when said end of each of said driven elements moves along said entrance slot portion and said exit slot portion so as to permit engagement of said second engaging element of said driven unit with said first engaging element of said worktable, thereby preventing rotation of said central shaft on said worktable.

2. The CNC machine tool as claimed in claim 1, wherein said rotating unit further includes a horizontal rotating disk connected fixedly to a top end of said rotating shaft and having a top surface that is provided with a rotating center element, which is eccentric from an axis of said rotating shaft, said CNC machine tool further comprising:
a carrier disposed vertically and movably relative to and above said machine bed and movable relative to said machine bed under the CNC control; and
a positioning element disposed fixedly on said carrier and movable in a vertical direction to engage said rotating center element of said rotating disk of said rotating unit so as to prevent displacement of said rotating center element relative to said positioning element and so as to permit rotation of said rotating center element relative to said positioning element such that said rotating disk can rotate about said rotating center element, thereby permitting rotation of said rotating shaft on said worktable.

3. The CNC machine tool as claimed in claim 1, wherein said positioning element is configured as a projecting post that extends downwardly from said carrier, and said rotating center element is configured as a cylindrical sleeve fixed on a top surface of said rotating disk, said carrier being movable so as to permit said positioning element to engage fittingly said sleeve such that said sleeve is sleeved rotatably on said positioning element.

4. The CNC machine tool as claimed in claim 1, further comprising a casing fixed on said worktable and having an outer surface that is provided with said first engaging element,
said central shaft having an inner end that is disposed in said casing, and an outer end that is disposed outside of said casing, said driven unit further including a vertical working disk that is adapted to mount a workpiece to be cut thereon, that is connected fixedly to said outer end of said central shaft, and that is disposed outside of said casing, said second engaging element being disposed fixedly on said working disk,
said spring member biasing said central shaft inwardly relative to said casing so as to move said working disk toward said casing, thereby permit engagement of said second engaging element with said first engaging element.

5. The CNC machine tool as claimed in claim 3, wherein said driven unit further includes a ring that is sleeved fixedly on said inner end of said central shaft,
said casing being provided with a stop member that is fixed therein and that is disposed between said ring and said driven elements,
said spring member being configured as a coiled compression spring that is sleeved on said central shaft and that is disposed between said ring and said stop member,
said clutch unit further including a vertical clutch shaft journal led on said worktable, a driven swing arm, and a driving swing arm, each of said driving and driven swing arms extending integrally, radially, and outwardly from said clutch shaft,
said rotating unit including a driving cam wheel that is sleeved fixedly on said rotating shaft and that is rotatable to engage and rotate said driven swing arm, said driving cam wheel including
a small-radius cam surface having a uniform radius, a leading end, and a tail end, engagement of said driven swing arm with said small-radius cam surface resulting in engagement of said first and second engaging elements, thereby preventing rotation of said central shaft of said driven unit on said worktable,
a large-radius cam surface having a uniform-radius that is larger than that of said small-radius cam surface, a leading end, and a tail end, engagement of said driven swing arm with said large-radius cam surface resulting in separation of said second engaging element from said first engaging element,
a driving cam surface having a leading end coupled with said tail end of said small-radius cam surface, a tail end coupled with said leading end of said large-radius cam surface, and a diameter increasing gradually from said leading end of said driving cam surface to said tail end of said driving cam surface, movement of said driven swing arm along said driving cam surface from said leading end of said driving cam surface to said tail end of said driving cam surface causing said driving swing arm to contact and push said ring toward said stop member so as to compress said spring member, thereby moving said central shaft from said connecting position to said disconnecting position,
a transitional cam surface having a leading end coupled with said tail end of said large-radius cam surface, a tail end coupled with said leading end of said small-radius cam surface, and a diameter reducing from said leading end of said transitional cam surface to said tail end of said transitional cam surface.

6. The CNC machine tool as claimed in claim 5, wherein said driven swing arm has a free end, which is provided with a rotatable roller that is movable along said small-radius cam surface, said driving cam surface, said large-radius cam surface, and said transitional cam surface of said driving cam wheel.

7. The CNC machine tool as claimed in claim 5, wherein each of said driven elements has an outer end, which is provided with a rotatable roller that is movable along said guiding slot in said guiding wheel.
